(19) United States
(12) Patent Application Publication
(10) Pub. No.: US 2017/0072664 A1
(43) Pub. Date: Mar. 16, 2017

(54) Laminated Glass Laminates Having Heat-Radiation-Shielding Properties Based On Thin Films Formed From Unplasticised Polyvinyl Acetal

(71) Applicant: KURARAY EUROPE GMBH, Hattersheim (DE)

(72) Inventor: Uwe KELLER, Hattersheim (DE)

(21) Appl. No.: 15/341,174

(22) Filed: Nov. 2, 2016

Related U.S. Application Data
(63) Continuation of application No. 14/601,553, filed on Jan. 21, 2015.

(30) Foreign Application Priority Data
Feb. 5, 2014 (EP) 14154020.3

(51) Int. Cl. B32B 17/10; B32B 27/08; B32B 37/15; B32B 27/30; B32B 27/22; B32B 37/18; B32B 3/26; B32B 27/14

(52) U.S. Cl. CPC B32B 17/10605; B32B 3/266; B32B 3/263; B32B 17/10568; B32B 17/10935; B32B 17/10633; B32B 27/08; B32B 27/14; B32B 27/30; B32B 27/22; B32B 37/182; B32B 37/15; B32B 17/10761; B32B 17/10651; B32B 2250/04; B32B 2307/304; B32B 2315/08; B32B 2329/00

(57) ABSTRACT

A heat-shielding laminated glass laminate contains at least one film A containing a polyvinyl acetal PA and optionally at least one plasticiser WA, and at least one film B containing a polyvinyl acetal PB and at least one plasticiser WB, positioned between two glass sheets, wherein prior to lamination:
a proportion of plasticiser WA of less than 16% by weight is dispersed in film A,
a proportion of plasticiser WB of at least 16% by weight is dispersed in film B, and
heat-shielding particles are dispersed in film A.

### CROSS-REFERENCE TO RELATED APPLICATIONS

This application is a continuation of U.S. application Ser. No. 14/601,553 filed Jan. 21, 2015, now pending, which, in turn, claims priority to European Patent Application No. 14154020.3 filed Feb. 5, 2014, the disclosures of which are incorporated in their entirety by reference herein.

### BACKGROUND OF THE INVENTION

1. Field of the Invention

The present invention relates to a method for producing laminated glass sheets having heat-shielding properties with use of a thin intermediate film based on unplasticised polyvinyl acetal.

2. Background Art

In order to produce laminated glass sheets having heat-shielding properties, methods in which thin PET films coated in an IR-absorbing or IR-reflecting manner are embedded between a plurality of layers of plasticiser-containing polyvinyl acetal are usual, inter alia. A disadvantage here is the fact that at least 3 film layers (1× functionalised PET, 2×PVB film) always have to be used, since PET cannot be melted directly on a glass surface via the functionalised side or the rear side.

Apart from various coating options of the glass surface, the alternative to this lies in the use of intermediate layer films which contain IR absorbers in the volume. By way of example, nanoscale semiconductor particles, such as ITO or ATO, for this purpose are distributed as uniformly as possible in the volume of the film during film production. A disadvantage here lies in the difficulty of retaining the nanoscale distribution of the particles in a plasticiser-containing film matrix during an extrusion method in the presence of various other ingredients so that agglomerations of the nanoparticles do not result in an unacceptable clouding. Another disadvantage is the increased complexity of the film production, which, due to the combination of the “heat-absorbing” feature with further functional features such as “acoustic damping”, “band filter”, “wedge-shaped thickness profile” and “shade”, leads to an increase of the range of products of the manufacturer and also of the processor.

As an alternative to this, WO 2005/059013 A1 proposes the application of heat-absorbing nanoparticles by printing PVB film with special printing inks. However, the adhesion properties of the film to the glass surface can be adversely affected by the printing. Due to the fact that PVB films must have a roughened surface in order to remove the air in a lamination process without difficulty, it is likely that a layer applied thereto, which is also partially absorbing in the visible range, will be optically uneven following pressing with a glass surface. In addition, the printing of thick plasticised film webs is difficult, since such films are elongated as they are unwound and may then shrink back again.

Heat-insulating films according to the prior art have heat-shielding particles which are dispersed in the plasticiser-containing layer. Since the inorganic particles can disperse only poorly in the used plasticiser, there is a risk of agglomeration of the particles and therefore of clouding of the film or of the glass laminate.

### SUMMARY OF THE INVENTION

The problem addressed by the present invention was therefore to provide intermediate layer films that have heat-shielding properties, without having to disperse nanoscale semiconductor particles in the volume of a plasticiser-containing intermediate layer film.

It has surprisingly and unexpectedly been found that heat-shielding particles can disperse very well in thin films based on polyvinyl acetal containing low levels of plasticiser or no plasticiser, and that these films can be melted directly on one of the glass surfaces in the typical production methods for laminated glass laminates.

The usual required safety properties of laminated glass laminates can then be obtained in combination with at least one layer formed of plasticiser-containing polyvinyl acetal.

### DETAILED DESCRIPTION OF THE PREFERRED EMBODIMENT(S)

The invention therefore relates to a heat-shielding laminated glass laminate, consisting of at least one film A containing a polyvinyl acetal PA and optionally at least one plasticiser WA and at least one film B containing a polyvinyl acetal PB and at least one plasticiser WB between two glass sheets, wherein, in each case prior to lamination
a proportion of plasticiser WA of less than 16% by weight is dispersed in film A,
a proportion of plasticiser WB of at least 16% by weight is dispersed in film B, and
heat-shielding particles are dispersed in film A.

Heat-shielding films are considered to be films which, with comparative measurement and evaluation according to ISO 13837:2008 (v=14 m/s; value in %) in a test laminate consisting of 2×2.1 mm clear glass (for example Planilux™) and, intermediately arranged as film B, a standard automotive film (for example TROSIFOL VG R10 0.76) as well as a film A without heat-shielding particles and an accordingly structured laminate, in which film A has heat-shielding particles, have a reduced total solar transmittance (TTS) as follows:

TTS (film A without particles)−TTS (film A with particles)>10%, >12.5%, >15%, >17.5% or >20%

In addition, the furnishing of film A with heat-shielding particles according to the invention, upon comparison and contrasting of the described test laminates can have the advantage that the light transmission (TL measured in accordance with EN 410; 2011, value in %) is reduced to a smaller extent by introduction of the heat-shielding particles, similarly to the total solar transmittance TTS (according to ISO 13837:2008 ,v=14 m/s; value in %).

Heat-shielding films A used in accordance with the invention preferably have quotients of TL/TTS, in order of increasing preference, of more than 1.2, more than 1.25, more than 1.30, more than 1.35, more than 1.40, or more than 1.45.

The heat-shielding films A can contain, as heat-shielding particles, for example ITO, ATO, AZO, IZO, zinc antimonates, tin-doped zinc oxide, silicon-doped zinc oxide, gallium-doped zinc oxide, tungstates, such as LiWO₃, NaWO₃, CsWO₃, lanthanum hexaboride or cerium hexaboride.

The heat-shielding particles preferably have a mean diameter from 5 to 500 nm. The proportion of heat-shielding particles in the films A may be 1-20% by weight, preferably 2-10% by weight.

The thickness of a film A in the starting state prior to lamination of the layers is 10-150 μm, preferably 20-120 μm.

Hereinafter, the term “starting state” is understood to mean the state of the films A and B prior to lamination, that is to say still in the separated state.

The films A and B may contain, in the starting state prior to lamination of the layers and also in the intermediate layer stack located in the laminated glass laminate, a single plasticiser as well as mixtures of plasticisers both of different and identical composition. The term “different composition” refers to both the type of plasticiser and proportion thereof in the mixture. Film A and film B after lamination, that is to say in the finished laminated glass, preferably have the same plasticisers WA and WB. In a preferred variant, film A in its starting state, however, does not contain any plasticiser and after lamination contains the plasticiser WB.

Plasticiser-containing films B used in accordance with the invention contain, in the starting state prior to lamination of the layers, at least 16% by weight, such as 16.1-36.0% by weight, preferably 22.0-32.0% by weight and in particular 26.0-30.0% by weight plasticiser.

Films A used in accordance with the invention may contain, in the starting state prior to lamination of the layers, less than 16% by weight (such as 15.9% by weight), less than 12% by weight, less than 8% by weight, less than 6% by weight, less than 4% by weight, less than 3% by weight, less than 2% by weight, less than 1% by weight, or even no plasticiser (0.0% by weight). Films A with a low plasticiser content preferably contain 0.0-8% by weight plasticiser.

In the method according to the invention, the film A in the starting state prior to lamination of the layers has a thickness of no more than 20%, preferably no more than 15%, and preferably no more than 10% of the thickness of the film or films B.

The thickness of a film A in the starting state prior to lamination of the layers is 10-150 μm, preferably 20-120 μm, more preferably 30-100 μm, yet more preferably 40-80 μm, and most preferably 50-70 μm. In the laminated glass, the thickness of the film increases by transfer of plasticiser from film B.

Film A is produced separately from film B (for example extruded) and has either no plasticiser at all or such a small proportion of plasticiser that the dispersion of the heat-shielding particles is not influenced adversely.

The thickness of a film B in the starting state is 450-2500 μm, preferably 600-1000 μm, more preferably 700-900 μm. With use of a plurality of films B, the same is true for the total thickness thereof. If films B are stretched prior to production of the sandwich and/or additionally are adapted to the shape of a screen (for example a windscreen) in a curved manner, the specified thicknesses at the moment of lamination may reduce once more by up to 20%.

At least one thin, heat-shielding film A is oriented relative to a glass surface of the laminated glass laminate according to the invention. It is also possible to apply a film A to both glass surfaces, such that a laminated glass laminate with a layer sequence glass/film A/film B/film A/glass is provided. Here, the decoration of the films A may be the same or different. By way of example, one of the films A may have heat-shielding particles, and the second film A may have electrically conductive structures, such as heating wires, antennas or other layers having optical functions.

In the case of automotive glazing, it is not preferable for aesthetic and stability reasons to seal the edges of the laminated glass laminates with sealants. This promotes the susceptibility of such glazings to the formation of edge defects, such as detachments of the layers from one another (delaminations) or corrosion or chemical modification of an IR-absorbing layer reaching as far as the edge of the laminate.

In the method according to the invention, the film A having a low plasticiser content can be tailor cut and positioned such that it does not reach everywhere in the laminated glass laminate as far as the edge of the laminate. In particular, the film A can be smaller in the edge region by at least 1 mm compared with at least one glass sheet, such that the film B in this edge region is in direct contact with at least one glass sheet.

Furthermore, the thin film A, which has a low plasticiser content or even no plasticiser content in the starting state, can be perforated prior to the insertion into the glass/film sandwich, such that it can have openings, such as passages, holes or slits, in any geometric patterns.

The film A can thus have at least one opening, such that by means of this opening the film B is in direct contact with the glass sheet bearing against film A. Following adhesive bonding to form the finished laminated glass, the film B with higher plasticiser content in the starting state is adhesively bonded at these points to the glass sheets without interruption. In particular, openings can thus be obtained at points of the laminated glass behind which the function of sensor elements, optical elements, and/or antenna elements would otherwise be hindered by a heat-shielding layer.

The films A and B used in accordance with the invention contain polyvinyl acetals, which are produced by acetalisation of polyvinyl alcohol or ethylene vinyl alcohol copolymer.

The films can contain polyvinyl acetals, each having a different polyvinyl alcohol content, degree of acetalisation, residual acetate content, ethylene proportion, molecular weight and/or different chain lengths of the aldehyde of the acetal groups.

In particular, the aldehydes or keto compounds used for the production of the polyvinyl acetals can be linear or branched (that is to say of the “n” or “iso” type) containing 2 to 10 carbon atoms, which leads to corresponding linear or branched acetal groups. The polyvinyl acetals are referred to accordingly as “polyvinyl (iso)acetals” or “polyvinyl (n)acetals”.

The polyvinyl (n)acetal used in accordance with the invention results in particular from the reaction of at least one polyvinyl alcohol with one or more aliphatic unbranched keto-compounds containing 2 to 10 carbon atoms. To this end, n-butyraldehyde is preferably used.

The polyvinyl alcohols or ethylene vinyl alcohol copolymers used to produce the polyvinyl acetals in the films A or B may be identical or different, pure or a mixture of polyvinyl alcohols or ethylene vinyl alcohol copolymers with different degree of polymerisation or degree of hydrolysis.

The polyvinyl acetate content of the polyvinyl acetals in the films A or B can be set by use of a polyvinyl alcohol or ethylene vinyl alcohol copolymer saponified to an appropriate degree. The polarity of the polyvinyl acetal is influenced by the polyvinyl acetate content, whereby the plasticiser compatibility and the mechanical strength of the respective layer also change. It is also possible to carry out the acetalisation of the polyvinyl alcohols or ethylene vinyl alcohol copolymers with a mixture of a number of aldehydes or keto compounds.

The films A or B preferably contain polyvinyl acetals having a proportion of polyvinyl acetate groups based on the layers, either identically or differently, of 0.1 to 20 mol %, preferably 0.5 to 3 mol %, or 5 to 8 mol %.

The polyvinyl alcohol content of the used polyvinyl acetals PA of film A having a lower plasticiser content in the starting state may be between 6-26% by weight, 8-24% by weight, 10-22% by weight, 12-21% by weight, 14-20% by weight, 16-19% by weight and preferably between 16 and 21% by weight or 10-16% by weight.

The polyvinyl alcohol content of the used polyvinyl acetals PB of film B, which is richer in plasticiser in the starting state, may be between 14-26% by weight, 16-24% by weight, 17-23% by weight and preferably between 18 and 21% by weight.

The films A or B preferably contain uncross-linked polyvinyl acetal. The use of cross-linked polyvinyl acetals is also possible. Methods for cross-linking polyvinyl acetals are described, for example, in EP 1527107 B1 and WO 2004/063231 A1 (thermal self-cross-linking of polyvinyl acetals containing carboxyl groups), EP 1606325 A1 (polyvinyl acetals cross-linked with polyaldehydes) and WO 03/020776 A1 (polyvinyl acetal cross-linked with glyoxylic acid).

Films A and/or B used in accordance with the invention may contain, as plasticiser, one or more compounds selected from the following groups:

esters of polyvalent aliphatic or aromatic acids, for example dialkyl adipates such as dihexyl adipate, dioctyl adipate, hexyl cyclohexyl adipate, mixtures of heptyl adipates and nonyl adipates, diisononyl adipate, heptyl nonyl adipate, and esters of adipic acid with cycloaliphatic ester alcohols or ester alcohols containing ether compounds, dialkyl sebacates such as dibutyl sebacate, and also esters of sebacic acid with cycloaliphatic ester alcohols or ester alcohols containing ether compounds, esters of phthalic acid, such as butyl benzyl phthalate or bis-2-butoxyethyl phthalate;

esters or ethers of polyvalent aliphatic or aromatic alcohols or oligo ether glycols with one or more unbranched or branched aliphatic or aromatic substituents, for example esters of glycerol, diglycols, triglycols or tetraglycols with linear or branched aliphatic or cycloaliphatic carboxylic acids; Examples of the latter group include diethylene glycol-bis-(2-ethyl hexanoate), triethylene glycol-bis-(2-ethyl hexanoate), triethylene glycol-bis-(2-ethyl butanoate), tetraethylene glycol-bis-n-heptanoate, triethylene glycol-bis-n-heptanoate, triethylene glycol-bis-n-hexanoate, tetraethylene glycol dimethyl ether and/or dipropylene glycol benzoate;

phosphates with aliphatic or aromatic ester alcohols, such as tris(2-ethylhexyl)phosphate (TOF), triethyl phosphate, diphenyl-2-ethylhexyl phosphate, and/or tricresyl phosphate; and

esters of citric acid, succinic acid and/or fumaric acid.

By definition, plasticisers are organic liquids having a high boiling point. For this reason, further types of organic liquids having a boiling point above 120° C. can also be used as plasticiser.

Films A in the variants in which a plasticiser WA is present in film A in the starting state, and also films B particularly preferably contain 1,2-cyclohexane dicarboxylic acid diisononyl ester (“DINCH”) or triethylene glycol-bis-2-ethyl hexanoate (“3GO” or “3G8”) as plasticiser.

In addition, films A and B may contain further additives, such as residual quantities of water, UV absorber, antioxidants, adhesion regulators, optical brighteners or fluorescent additives, stabilisers, colorants, processing aids, organic nanoparticles, pyrogenic silicic acid and/or surface active substances. In particular, film B may comprise 0.001 to 0.1% by weight of alkaline salts and/or alkaline earth salts of carboxylic acids as adhesion regulators.

In order to avoid corrosion at the heat-shielding particles, film A preferably comprises less than 150 ppm chloride ions and/or nitrate ions and/or sulphate ions.

The chloride content of the film A can thus be less than 150 ppm, preferably less than 100 ppm, and in particular less than 50 ppm. In the ideal case, the chloride content of the film A is less than 10 ppm or even 0 ppm.

The nitrate content of film A optionally may be less than 150 ppm, preferably less than 100 ppm, and in particular less than 50 ppm. In the ideal case, the nitrate content of film A is less than 10 ppm or even 0 ppm.

Again optionally, the sulphate content of film A may be less than 150 ppm, preferably less than 100 ppm, and in particular less than 50 ppm. In the ideal case, the sulphate content of the film A is less than 10 ppm or even 0 ppm.

Film A additionally may comprise more than 0 ppm magnesium ions. The magnesium content is preferably more than 5 ppm, more preferably 10 ppm, and in particular 5-20 ppm

The present invention also relates to a method for producing the described heat-shielding laminated glass laminates, in which the film A is positioned on a glass sheet, is then covered by at least one film B, and a second glass sheet is then applied.

Alternatively, it is possible for film B to be positioned on a glass sheet, then to be covered by at least one film A, and for a second glass sheet to be applied. Of course, it is also possible first to bring together film A and film B and then to position these jointly on a glass sheet.

It is possible in accordance with the invention to first melt the film A onto a glass sheet over the entire area or locally by increased temperature and to then cover this with the film B. Alternatively, films A and B can be positioned jointly between two glass sheets and melted at increased temperature.

The lamination step for producing a laminated glass is preferably carried out such that films A and B are positioned between two glass sheets and the layered body thus prepared is pressed under increased or reduced pressure and increased temperature to form a laminate.

To laminate the layered body, the methods with which a person skilled in the art is familiar can be used, with and without prior production of a pre-laminate.

What are known as autoclave processes are carried out at an increased pressure from approximately 10 to 15 bar and temperatures from 100 to 145° C. over approximately 2 hours. Vacuum bag or vacuum ring methods, for example according to EP 1 235 683 B1, function at approximately 200 mbar and 130 to 145° C.

What are known as vacuum laminators can also be used. These consist of a chamber that can be heated and evacuated, in which laminated glazings can be laminated within 30-60 minutes. Reduced pressures from 0.01 to 300 mbar and temperatures from 100 to 200° C., in particular 130-160° C., have proven their worth in practice.

In the simplest case, in order to produce the laminated glass laminates, film A or B is positioned on a glass sheet, and the further film B or A is positioned synchronously or subsequently. The second glass sheet is then applied and a glass film laminate is produced. Excessive air can then be removed with the aid of any pre-lamination method known to a person skilled in the art. Here, the layers are also already firstly lightly adhesively bonded to one another and to the glass.

The glass film laminate may then be subjected to an autoclave process. Film A is preferably positioned on the first glass sheet and covered by the thicker film B before the second glass sheet is applied. The method can be carried out in many conceivable and, in principle, practicable variants. For example, film A is easily removed from a roll of an appropriate width, whereas film B has been tailor-cut beforehand to the size of the laminated glass to be produced. This is advantageous in particular in the case of windscreens and other automotive glazing parts. In this case, it is particularly advantageous to additionally still stretch the thicker film B before it is tailor cut. This enables a more economical use of film, or, for the case in which film B has a colour tint, allows the adaptation of the curvature thereof to the upper sheet edge.

In the automotive field, in particular for the production of windscreens, films that have what is known as an ink ribbon in the upper region are often used. To this end, either the upper part of films A and B can be co-extruded with a suitably coloured polymer melt, or there may be a different colouration in some areas in a multi-layer system of one of the films A and B. In the present invention, this can be achieved by complete or partial colouring of at least one of the films A and B.

In accordance with the invention, films B may therefore have a colour tint, which in particular has already been adapted in a prior process step to the geometry of a windscreen.

It is also possible for the films B to have a wedge-shaped thickness profile. The laminated glass laminate according to the invention obtains a wedge-shaped thickness profile even with plane-parallel thickness profile of the film A and can be used in motor vehicle windscreens for HUD displays.

In the simplest case, film B is a commercially available PVB film with or without ink ribbon and with or without a wedge-like thickness profile. Films B with nanoparticles dispersed therein for IR protection can also be used as coloured films. Of course, a film B may also be a film having an acoustic function, such that soundproofing properties that are further improved are obtained by combination with a film A. Of course, a film B may already also combine a number of the mentioned functions.

The thin films A are generally produced by extrusion with use of a cast-film line or in the form of a blown film. Here, a surface roughness may also be produced by controlled flow crack or with the cast-film method additionally by use of a structured chill roll.

In addition, a film already produced can be embossed with a regular, non-stochastic roughness by means of an embossing process between at least one cylinder pair. Films used in accordance with the invention preferably have a one-sided surface structure with a roughness Rz from 0 to 25 μm, more preferably an Rz from 1 to 20 μm, yet more preferably an Rz from 3 to 15 μm, and in particular, an Rz from 4 to 12 μm. It is particularly preferable if the side of film A coming into contact with the glass sheet has a surface roughness Rz of no more than 20% of its thickness. The surface provided with the heat-shielding coating preferably has a particularly low surface roughness prior to application of the coating. In particular, the roughness parameter Ra here is less than 3 μm and Rz is less than 5 μm.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A heat-shielding laminated glass laminate, comprising at least one film A containing a polyvinyl acetal PA and optionally at least one plasticiser WA and at least one film B containing a polyvinyl acetal PB and at least one plasticiser WB between two glass sheets, wherein in each case prior to lamination
a proportion of plasticiser WA of less than 8% by weight is dispersed in film A,
a proportion of plasticiser WB of at least 16% by weight is dispersed in film B, and
heat-shielding particles are dispersed in film A,
wherein film A, prior to lamination, has a thickness of no more than 20% of the thickness of film or films B, and wherein during or following lamination, plasticizer migrates into film A from film B.

2. The heat-shielding laminated glass laminate of claim 1, wherein the heat-shielding particles of film A contain at least one compound selected from the group consisting of ITO (indium-doped tin oxide), ATO (antimony-doped tin oxide), AZO (antimony-doped tin oxide), IZO (indium-doped zinc oxide), zinc antimonates, tin-doped zinc oxide, silicon-doped zinc oxide, gallium-doped zinc oxide, LiWO₃, NaWO₃, CsWO₃, and lanthanum hexaboride.

3. The heat-shielding laminated glass laminate of claim 1, wherein the heat-shielding particles have a mean diameter from 5 to 500 nm.

4. The heat-shielding laminated glass laminate of claim 1, wherein the film A comprises a polyvinyl acetal PA with a proportion of vinyl alcohol groups from 6 to 26% by weight and the film B comprises a polyvinyl acetal PB with a proportion of vinyl alcohol groups from 14 to 26% by weight.

5. The heat-shielding laminated glass laminate of claim 1, wherein the film B comprises 0.001 to 0.1% by weight alkaline and/or alkaline earth salts of carboxylic acids.

6. The heat-shielding laminated glass laminate of claim 1, wherein the film A has a smaller surface area than film B.

7. The heat-shielding laminated glass laminate of claim 1, wherein the film A has at least one opening, such that by means of this opening the film B is in direct contact with the glass sheet bearing against film A.

8. The heat-shielding laminated glass laminate of claim 1, wherein the film B consists of at least two sub-films B′ and B″, which have a different plasticiser content.

9. The heat-shielding laminated glass laminate of claim 1, wherein the film B has a wedge-shaped thickness profile.

10. The heat-shielding laminated glass laminate of claim 1, wherein the film B has a coloured region.

11. The heat-shielding laminated glass laminate of claim 1, wherein film A has a coloured region.

12. The heat-shielding laminated glass laminate of claim 1, wherein the film A has a thickness of 1-150 μm.

13. The heat-shielding laminated glass laminate of claim 1, wherein film A has less than 150 ppm chloride ions and/or nitrate ions and/or sulphate ions.

14. The heat-shielding laminated glass laminate of claim 1, wherein film A has more than 0 ppm magnesium ions.

15. A method for producing a laminated glass laminate of claim 1, wherein the film A is positioned on a glass sheet, is then covered by at least one film B, and a second glass sheet is then applied.

16. The heat-shielding laminated glass laminate of claim 1, wherein film A, prior to lamination, has a thickness of no more than 15% of the thickness of film or films B.

17. The heat-shielding laminated glass laminate of claim 1, wherein film A, prior to lamination, has a thickness of no more than 10% of the thickness of film or films B.

18. The glass laminate of claim 1, wherein the polyvinyl alcohol content of the polyvinyl acetal of film A is between 10 and 16 weight percent, and the polyvinyl alcohol content of the polyvinyl acetal of film B is between 18 and 21 weight percent, the weight percents based on the weight of the respective polyvinyl acetal.

19. The glass laminate of claim 1, wherein film A, prior to laminating, contains 0-4 weight percent plasticizer, based on the weight of film A.

20. The glass laminate of claim 1, wherein the ratio of the light transmittance TL to total solar transmittance TTS is greater than 1.2.
